(19) United States
(12) Patent Application Publication
(10) Pub. No.: US 2006/0094798 A1
(43) Pub. Date: May 4, 2006

(54) Method of emulsifying substituted cyclic dicarboxylic acid anhydride sizing agents and emulsion for papermaking

(76) Inventors: Terrence Edward Cotter, Kennesaw, GA (US); Stephen R. Kurowsky, Pine Mountain, GA (US); Gary M. Freeman, Macon, GA (US)

Correspondence Address: CLARK & BRODY, 1090 VERMONT AVENUE, NW, SUITE 250, WASHINGTON, DC, 20005, US

(21) Appl. No.: 10/980,166

(22) Filed: Nov. 4, 2004

(51) Int. Cl. C08L 63/00; B01F 17/00

(52) U.S. Cl. 523/402; 162/164.6; 162/158; 516/71

(57) ABSTRACT

A method of emulsifying a substituted cyclic dicarboxylic acid anhydride sizing agent such as alkenyl succinic anhydride (ASA), primarily for papermaking operations, uses a cationic reaction polymer synthesized from an epihalohydrin and a polyamine, preferably a polyalkyleneamine. The synthesis of the reaction product is controlled to obtain a polymer end product viscosity, by Brookfield, ranging between 50 and 300 cps at 25° C. and at 30 to 35% solids. Alternatively, the preferred cationic polymers can be described as having an intrinsic viscosity value in a 0.2M NaCl solution of 0.18 to 0.35 dL/gm at 30° C. The polyamine-epihalohydrin polymers can also be optionally used in combination with a surfactant for further emulsifying of the ASA size.

### FIELD OF THE INVENTION

The present invention is directed to a method of emulsifying substituted cyclic dicarboxylic acid anhydride sizing agents such as alkenyl succinic anhydride (ASA) for papermaking and a papermaking sizing emulsion, and particularly to a method that uses a cationic polymer reaction product synthesized from an epihalohydrin and a polyamine as the emulsifying agent.

### BACKGROUND ART

With the growing commercial use of cellulose-reactive sizing agents, problems have remained in the application of the sizes to paper stock or pulp prior to its formation into sheet or other useful forms. Part of the problem has been that the sizing materials, like ASA, are not water soluble, and must, accordingly, be uniformly suspended in the pulp so that the size can make adequate contact with the cellulosic fibers and thus create the desired effect on the final product.

The use of cationic agents as additives or emulsifiers for alkenyl succinic anhydride (ASA) sizes for papermaking is well known in the art. One class of preferred emulsifying agents includes various cationic starches. Another class of agents includes organic amines and their corresponding amine salts or quaternary ammonium compounds as detailed in U.S. Pat. No. 5,759,249. Yet another class of emulsifying agents for ASA are cationic charged, water soluble vinyl-addition polymers having molecular weights greater than 10,000 and below 1,000,000 as detailed in U.S. Pat. No. 4,675,946 to Rende et al., owned by Nalco (hereinafter the Nalco patent), and incorporated herein in its entirety by reference. While the cationic charged, water soluble vinyl-addition polymers of the Nalco patent were developed as an alternative to cationic starches, these polymers still have drawbacks that establish a need in the art for improved polymeric cationic agents for emulsifying ASA. For example, the cationic polymers of the Nalco patent are copolymers of acrylamide that are complicated to manufacture and are high in cost due to their co-use of quaternary amine functional acrylate or methacrylate monomers such as DMAEA Me Cl quat (dimethylaminoethylacrylate methyl chloride quaternaries) or DMAEM Me Cl quat (dimethylaminoethylmethacrylate methyl chloride quaternaries).

Another problem facing the prior art is the need for economic alternatives to the use of cationic starches for sizing. Many small papermaking operations, especially those that produce sized cover sheets for gypsum wallboard, are not equipped to produce these types of starches at the paper mill site. Alternatives to cationic starches such as the cationic polymeric emulsifying agents disclosed in the Nalco patent, while eliminating the need for starch making equipment, are expensive to make, and therefore burdensome to the small papermaking operation.

Consequently, there is a need for improvements in the production of ASA size emulsions for papermaking processes, particularly those that rely on either expensive cationic polymers or cationic starches. The present invention responds to this need by emulsifying ASA for its use in papermaking with a cationic polymer reaction product made from the condensation reaction of a polyamine and an epihalohydrin.

These types of cationic polymer reaction products are known in the art as disclosed in U.S. Pat. No. 6,228,219 to Erhardt. However, Erhardt is concerned with sizing paper using rosin at a pH of about 5.0-8.5. The reaction products of Erhardt, e.g., polyalkyleneamine-epihalohydrin resins, function as retention aides that are intended to anchor the rosin size to the fibers. The polymers are not taught to emulsify an ASA size as contemplated by the present invention.

U.S. Pat. No. 6,489,040 to Rohlf discloses a wallboard with resistance to roll up. Rohlf uses a cationic polyamide resin during the making of cover sheet for the wallboard in order to decrease post-manufacturing problems such as roll up or delamination/splitting of the sheet. According to Rohlf, cationic polyamides, such as epi-polyamidoamines, are known to function as wet strength agents for paper. Epi-polyamidoamines are formed by reacting a polyamine such as diethylenetriamine (DETA) with adipic acid to form, via condensation, a polyamide polymer having internal secondary amine groups between the amides and then subsequently reacting this polyamide with epichlorohydrin. However, Rohlf does not teach or suggest the use of a cationic polymer reaction product derived from the reaction of epihalohydrin with a polyamine as an emulsifier for ASA size.

U.S. Pat. No. 5,759,249 to Wasser discloses the use of an organic amine or alternatively the corresponding amine salt or corresponding quaternary ammonium compound of the organic amine as emulsifying agents for cellulose-reactive sizing agents such as ASA. The amount of emulsifying agent employed is typically about 3% to about 20% by weight of the ASA size. These sizing emulsions can further comprise a small amount of a cationic polymer, as a stabilizer for the emulsion, wherein the cationic polymer concentration is in the range from 0.01% to about 5% by weight of the total emulsion weight. A wide array of different stabilizing polymers were named in the patent. Included in this list were cationic condensation polymers such as amine-epichlorohydrin polymers; however, the cationic polymers of the Wasser invention are used in small additive amounts as auxiliary stabilizers for the sizing emulsions and this art does teach or suggest the use of polyamine-epihalohydrin polymers as the primary emulsifier for ASA. A representative amine-epichlorohydrin polymer is Kemira Chemical's Callaway 4000 product, which is derived from the condensation of dimethylamine with epichlorohydrin, and this cationic polymer is not an effective emulsifier for ASA sizing agents as compared to the polyamine-epihalohydrin polymers of this invention. Amine-epichlorohydrin polymers, such as Callaway 4000, are linear rather than being cross-linked structures like the cationic polymers of our invention.

### SUMMARY OF THE INVENTION

It is a first object of the invention to provide a method of emulsifying a substituted cyclic dicarboxylic acid anhydride sizing agent such as alkenyl succinic anhydride (ASA), and one particularly adapted for use in papermaking.

Another object of the invention is to emulsify the sizing agent using a cationic polymer reaction product having a defined viscosity which is an indirect measure of the polymer's molecular weight and degree of cross-linking.

One other object of the invention is a sizing emulsion composition, particularly useful for papermaking, and especially for sizing cover sheets used in gypsum wallboard applications.

Yet another object or benefit of the instant invention includes the proper control of particle size of a substituted cyclic dicarboxylic acid anhydride sizing agent such as an alkenyl succinic anhydride (ASA) by the use of the cationic polyamine-epihalohydrin polymers of this invention. The inventive cationic polymers can also be used for this purpose in combination optionally with small amounts of surfactant based emulsifiers. However, if sufficient energy is available by appropriate equipment choice, the ASA sizes of this invention may optionally eliminate the use of the additional surfactant. In other words the paper sizing performance obtained with the instant invention may be drastically improved by the use of either very small amounts of surfactant or with appropriate mixer energy availability with the use of only a sizing agent such as alkenyl succinic anhydride in combination with the cationic polymer within the prescribed weight ratios of cationic polymer to ASA. Typically the lower the amount of surfactant based emulsifier that is needed for sizing agent emulsification the better the sizing results on paper, with a surfactant free emulsified sizing agent being ideal for use in papermaking operations.

Still another object of the invention is a method of making a cellulose reactive sizing emulsion of a substituted cyclic dicarboxylic acid anhydride sizing agent such as alkenyl succinic anhydride (ASA) that is low in cost and uses easy-to-manufacture components.

Other objects and advantages of the present invention will be apparent as a description thereof proceeds.

In satisfaction of the foregoing objects and advantages of the invention, the invention is an improvement in methods of emulsifying substituted cyclic dicarboxylic acid anhydride sizing agents such as alkenyl succinic anhydride (ASA) using cationic reaction polymers. According to the invention, the substituted cyclic dicarboxylic acid anhydride sizing agent is emulsified with a cationic polymer that is a condensation reaction product of an epihalohydrin and a polyamine, wherein the reaction polymer product in a final product stage has a 60 rpm Brookfield viscosity range of between 50 and 300 cps at 25° C. and 30-35% solids. In terms of intrinsic viscosity, these polyamine-epihalohydrin polymers can have a value of about 0.18-0.35 dL/gm as measured at 30° C. in a 0.2M NaCl solution.

The polyamine is preferably a polyalkyleneamine, and more preferably one of bishexamethylenetriamine, triethylene tetraamine, and diethlyene triamine. The epihalohydrin is preferably epichlorohydrin, but other types of epihalohydrins can be employed. Preferred ranges for the viscosity of the final cationic polymer product are between 175 and 225 cps when measuring its Brookfield viscosity at 30-35% solids and 25° C. and between 0.25 and 0.34 dL/gm when measuring its intrinsic viscosity in a 0.2M NaCl solution at 30° C.

The substituted cyclic dicarboxylic acid anhydride is preferably one that has the formula:

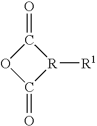

wherein R is a dimethylene or trimethylene radical and wherein R¹ is a hydrophobic substituent containing more than 5 carbons, and is more preferably an alkenyl succinic anhydride.

It is preferred that an active weight ratio of the cationic reaction polymer to the substituted cyclic dicarboxylic acid anhydride ranges between about 0.20 to 2.0 parts of the cationic reaction polymer to 1.0 part of the substituted cyclic dicarboxylic acid anhydride.

When synthesizing the cationic reaction polymer, the viscosity of the product being synthesized is monitored, and when a target viscosity is reached, the reaction is terminated by adjustment of the pH of the solution, preferably using sulfuric acid at pH ranges of from 2.5 to 5.2.

The invention also entails the use of the emulsified substituted cyclic dicarboxylic acid anhydride by adding an effective amount for sizing purposes to one or more sites in a papermaking operation. Preferably, the sites include sites on the wet end of the papermaking operation or at or near a size press of the papermaking operation, and the papermaking operation produces cover sheet for gypsum wallboard.

When using the emulsified substituted cyclic dicarboxylic acid anhydride size in the papermaking operation, the amount of the emulsified size, on an active basis, preferably ranges from about 0.1 to about 20 pounds per dry ton of paper.

The invention also entails employing an effective amount of a surfactant for enhanced emulsification and particle size control with the cationic reaction polymer and substituted cyclic dicarboxylic acid anhydride size. The surfactant amount is preferably about 3% or less by weight based on the dry weight of the emulsified substituted cyclic dicarboxylic acid anhydride.

In addition to the method of making the emulsified size, the invention also includes the emulsion itself as a cationic polymer emulsifying agent and a substituted cyclic dicarboxylic acid anhydride, wherein the cationic polymer emulsifying agent is formed from the condensation reaction of the epihalohydrin and the polyamine, the cationic reaction polymer in a final product stage having the aforementioned Brookfield viscosity range or intrinsic viscosity value range. Other and additional features of the emulsion of the invention in terms of: (1) the types of polyamine, epihalohydrin, and substituted cyclic dicarboxylic acid anhydride used; (2) the active weight ratio of the cationic reaction polymer to the substituted cyclic dicarboxylic acid anhydride; (3) the surfactant use and loading; and (4) preferred cationic polymer viscosity ranges are described above in connection with the emulsion's method of making.

Another aspect of the invention entails a paper composition that has been treated with the emulsified sizing agent as the substituted cyclic dicarboxylic acid anhydride and the effective amount of a cationic reaction polymer formed from the condensation reaction of the epihalohydrin and the polyamine. This paper composition can be derived from virtually any cellulosic fiber-containing paper source, can have any known form, and the form can be made using any known process. The amount of the emulsified sizing agent added as the combination of the dicarboxylic acid anhydride size and cationic reaction polymer ranges in amount from about 0.1 to about 20 pounds of active basis substituted cyclic dicarboxylic acid anhydride size per dry ton of the cellulosic fibers wherein the active weight ratio of the cationic reaction polymer to the substituted cyclic dicarboxylic acid anhydride size ranges between about 0.20 to 2.0 parts of the cationic reaction polymer to 1.0 part of the substituted cyclic dicarboxylic acid anhydride size. Other and additional features of the paper composition of the invention in terms of: (1) the types of polyamine, epihalohydrin, and substituted cyclic dicarboxylic acid anhydride size used; (2) any surfactant use and loading; and (3) preferred cationic polymer viscosity ranges are described above in connection with the emulsion's method of making and the emulsion itself.

### BRIEF DESCRIPTION OF THE DRAWINGS

Reference is now made to the drawings of the invention wherein FIG. 1 is a flow chart showing sizing material manufacture for papermaking.

FIG. 2 is a statistical analysis based contour performance plot of HST sizing performance, whereby the ASA sizing agent is dosed at a constant 4 lbs/ton, is contour plotted as a function of both cationic polymer to ASA “active basis” weight ratio and cationic polymer viscosity.

FIG. 3 is a statistical analysis based contour performance plot of HST sizing performance, whereby ASA emulsions prepared with a single cationic polymer of 200 cps viscosity are contour plotted as a function of both cationic polymer to ASA “active basis” weight ratio and ASA dosage level.

FIG. 4 is a statistical analysis based contour performance plot of HST sizing performance, whereby ASA emulsions prepared at a constant “active basis” weight ratio of cationic polymer to ASA of 1:1 are contour plotted as a function of both cationic polymer viscosity and ASA dosage level.

### DESCRIPTION OF THE PREFERRED EMBODIMENTS

The present invention provides a significant improvement in the sizing of paper using ASA. In contrast to prior art systems that require the manufacture of cationic starches at the papermaking operation or expensive and difficult to manufacture cationic polymers for emulsifying ASA, the present invention provides a simple and economically attractive way to emulsify ASA for papermaking operations. Furthermore, the inventive cationic polymers enable effective ASA emulsions to be produced without the use of high concentrations of surfactants and in many cases completely eliminate the need for other emulsifiers. The inventive system also provides improved HST sizing performance over cationic starches as well as other emulsification approaches using vinyl-addition based cationic polymers as the emulsifying agent.

The sizing agents useful in the instant invention include substituted cyclic dicarboxylic acid anhydrides. Preferably, the sizing agents are of the formula (I): 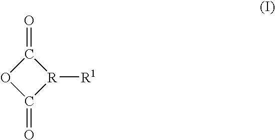
wherein R is a dimethylene or trimethylene radical and wherein R is a hydrophobic substituent containing more than 5 carbons. Preferably, R¹ is a linear or branched alkyl, alkenyl, aralkyl, or aralkenyl group. Most preferably, the sizing agents of the instant invention are alkenyl succinic anhydrides (ASA). Specific examples of sizing agents useful in the instant invention are iso-octadecenyl succinic anhydride, n-hexadecenyl succinic anhydride, dodecenyl succinic anhydride, decenyl succinic anhydride, dodecyl succinic anhydride, octenyl succinic anhydride, triisobutenyl succinic anhydride, 1-octyl-2-decenyl succinic anhydride, 1-hexyl-2-decenyl succinic anhydride, etc. and mixtures thereof. The ASA sizes to which this invention is applicable include those mentioned in U.S. Pat. Nos. 3,102,064, 4,040,900, 3,968,005, and 3,821,069, all of which are hereinafter incorporated by reference.

The ASA sizing emulsions of the instant invention may be advantageously employed e.g. in a papermaking process by adding them to a cellulosic composition e.g. a paper stock, paper web, etc., in the usual manner and in amounts effective to size paper that is formed from the cellulosic compositions in the normal course of the papermaking process. The amounts of ASA size employed, on an active basis, can range from about 0.1 to about 20 pounds, preferably about 0.5 to about 10 pounds, per dry ton of paper depending on the level of benefit desired and the type of paper being produced. The ASA sizing emulsion is preferably metered to the paper machine, and is preferably added to thin stock at any point where good mixing is available. The ASA sizing emulsion may also be applied directly to a paper web formed from the paper stock, preferably by spraying or by size pressing by applying at the size press.

One significant advantage of the invention is the ability to use the cationic polymer reaction product in mills that make sized paper for use as the cover sheet in gypsum wallboard applications. Many paper and paperboard products are sized with cellulose-reactive sizes, such as ASA, that have been emulsified with cationic starches. In order to size paper with ASA emulsions that employ cationic starches, the mills typically need a starch manufacturing system, including a starch storage silo, a starch cooker, starch heat exchanger, and transport piping in proximity to the paper mill. Since many of the mills producing the sized cover sheet for gypsum wallboard are relatively small in size, they do not have the starch making equipment, or are not inclined to use existing equipment due to the operational difficulties, or cannot afford to buy expensive emulsifiers such as liquid starches. These mills would benefit greatly from the invention in employing a ready-to-use and economical cationic polymer as the ASA emulsifier in their mill operation.

Besides being an effective substitute for cationic starches, using the polyamine-epihalohydrin cationic polymers of the instant invention as an ASA emulsifying agent also produces advantages in terms of:
1) lower cost as compared to liquid starch systems;
2) lower costs as compared to installing starch emulsification systems;
3) better HST sizing performance as compared to other cationic polymer systems;
4) better sizing performance as compared to cationic starches;
5) providing good ASA emulsion particle size control; and
6) often eliminates the need for using other emulsifying agents, such as surfactants.

Important to the aim of the invention is the use of a synthetic water-soluble cationic polymer that is a condensation reaction product of an epihalohydrin, preferably an epichlorohydrin, and a polyamine, preferably a polyalkyleneamine. No vinyl-based or acrylate-based monomers are employed in making the polymeric reaction product of the instant invention. The resultant cationic polymer reaction product is highly cross-linked in contrast to the essentially linear polymer structures associated with many other cationic polymers. The cationic polyamine-epihalohydrin polymer is produced in the desired molecular weight and degree of cross linking, as assessed by its viscosity properties, for its subsequent use as an emulsifier for ASA.

Because the cationic polymer reaction products of this invention are highly cross-linked, it is difficult to characterize them using standard molecular weight techniques such as gel permeation chromatography (GPC). Consequently, various polymer viscosity properties, which are an indirect measurement of their molecular weight and degree of cross linking, are used as a measure of the utility of the produced condensation polymer. Use of viscosity as the measure of the effectiveness of the cationic reaction product is reinforced by the fact that the polymer's finished product viscosity is important in establishing adequate sizing performance of the resultant ASA emulsions prepared with the polymer as an emulsifying agent. For example, if the cationic polymer's viscosity is too low, the cationic condensate polymer when combined with ASA yields an ASA emulsion that does not provide adequate sizing performance to paper or paperboard products.

If the cationic polymer's viscosity is too high, then paper sizing performance with the resultant ASA emulsions is generally not compromised. However, other problems are created, including formation of deposits in the papermaking operation, as well as manufacturing issues in terms of handling the viscous polymer such as pumping or metering it accurately to correctly produce the cationic polymer/ASA emulsions that are to be applied to the paper machine. Consequently, the final product viscosity of the preferred cationic polyamine-epihalohydrin polymer when measured at 25° C. and 30-35% polymer solids should range between 50 and 300 cps, as determined by a LVT Brookfield viscometer at 60 rpm, with a more preferred Brookfield viscosity range being between 175 and 225 cps. In terms of intrinsic viscosity, the preferred polyamine-epihalohydrin polymers have a corresponding value of about 0.18-0.35 dL/gm as measured at 30° C. in a 0.2M NaCl solution while a more preferred intrinsic viscosity value for the polymers ranges from 0.25-0.34 dL/gm.

A preferred chemistry to form the cationic condensation polymers of the invention is a reaction between bis-hexamethylenetriamine (BHMT) and epichlorohydrin (Epi). One source of the BHMT polyamine is a waste stream from the manufacture of nylon that has been semi-purified by a crude distillation process. The as-received BHMT is then diluted with water and is combined with Epi in an exemplary molar ratio of about 1:4.25(BHMT:Epi). The mixture is heated and polymerized by the addition of an effective amount of caustic soda (NaOH). Sufficient Epi is used in the reactions to convert the amine groups to tertiary and/or quaternary ammonium groups thus imparting some cationic charge to the polymer and some degree of cross-linking. The resulting reaction product is therefore a cross-linked polymer that is dispersible or soluble in water whose exact structure is not known with certainty.

A more detailed example of the synthesis of the cationic polymer of the invention using bishexamethylenetriamine or (BHMT) is as follows:

A 3 liter, four-necked, double walled glass flask with a built in sampling valve was equipped with a Caframo overhead mechanical stirrer with an attached stainless steel shaft having three (3) propellers, a condenser and a thermocouple. Heating and cooling were provided by a Thermo NesLab RTE 7 recirculating heater/cooler. Samples were taken along the reaction profile through a sampling valve for the purpose of measuring pH and solution viscosity.

Into the flask was added 2313.6 grams of a bishexamethylenetriamine (BHMT) solution, which is typically about 25% active BHMT, and mixing was started. Next, 551.9 grams of tap water was added. After mixing for a minimum of 5 minutes, a sample of the mixture was taken and titrated with 0.5 N HCl. Since the BHMT solution is a byproduct of nylon manufacture, it contains small amounts of other amines and impurities. To adjust the mixture to the desired reaction concentration, the solution is titrated to a range of 2.5-2.7 meq of acid per gram of solution. The flask was cooled to 14° C. and 866.88 grams of epichlorohydrin (Epi) was charged in less than 5 minutes. After the Epi charge was completed, the temperature exothermed and peaked below 100° C. Cooling was removed and the reaction temperature was lowered to 76±2° C. and maintained for 30 minutes. A sample was taken as described above for a pH and a solution viscosity (LVT, spindle #1, 60 rpms, 65° C.). Next, 88.2 grams of a 30% sodium hydroxide solution was added. After 30 minutes a second sample was taken for pH and viscosity. An additional 29.4 grams of the 30% sodium hydroxide solution was added. After a 30 minute hold time, an additional 29.4 grams of the 30% sodium hydroxide solution was added. This step was repeated one additional time. At this point the solution viscosity was below 40 cps, therefore, two 10 gram shots of the 30% sodium hydroxide solution were made. When the reaction mixture reached a solution viscosity of 50 cps, the temperature was lowered to 66° C. to build viscosity slowly. At this point in the process, the total batch reactor solids are about 38.3% as calculated on the basis of the combined active basis weights of Epi, BHMT plus caustic divided by the total batch weight. At 70 cps (as measured at 65° C.), the reaction was terminated by adding 31.6 grams of 95% sulfuric acid and 59.5 grams of tap water. By using the above reaction scheme, any desired final solution viscosity, i.e. molecular weight, can be achieved simply by termination with acid at any point along the reaction profile. The above reaction product and all samples taken for monitoring were adjusted to a pH of about 5.0±0.2 and a solids content of 35±1% to create a final product for use. The solution viscosity of the final product at pH of about 5.0 as measured by Brookfield at 25° C. was 265 cps.

It should also be noted that in reacting BHMT with Epi, in analogy to the procedure described above, that BHMT-Epi polymers of higher cross-link density that still have final product viscosities in the range of 50 to 300 cps (by Brookfield at 35% solids and 25° C.) can be produced. This is achieved in the process by lowering the amount of initial batch water and thereby increasing the total batch reactor solids. The ratio of Epi to BHMT employed in the reaction therefore remains the same. For example, a BHMT-Epi reaction process was successfully carried out whereby the total batch reactor solids (as based on the combined amounts of Epi+BHMT+caustic, but prior to acidification with sulfuric acid) was 44.8%. Given the higher solids content of this reaction, the peak exothermic temperature that was observed after completion of the Epi charge to the BHMT solution was about 123° C. A finished BHMT-Epi polymer of 160 cps viscosity was ultimately produced based on the selected time point of reaction termination with sulfuric acid. From intrinsic viscosity based measurements, BHMT-Epi polymers produced by this higher solids, higher peak temperature process (i.e., 44.8% solids and 123° C.) are found to yield cationic polymers that are in general more cross-linked versus the cationic polymers made by the previously described reaction process conducted at 38.3% solids with a peak exothermic temperature of <100° C. The issue of intrinsic viscosity measurements and polymer cross-linking are discussed later on in greater detail.

Other exemplary chemistries include the use of either triethylene tetraamine (TETA) or diethylene triamine (DETA) with epichlorohydrin. Examples of the synthesis of polymers using these materials is as follows:

Reaction of Triethylene Tetraamine and Epichlorohydrin

Using the same equipment as described above for the synthesis involving BHMT, 379.7 grams of triethylene tetraamine (TETA) were added to the 3 liter flask and mixing was started. Next, 2360 grams of tap water were added. The flask was cooled to 13° C. and 820.3 grams of epichlorohydrin (Epi) was added over 5 minutes. After the temperature had peaked, the reaction temperature was adjusted to 76±2° C. After 30 minutes, a sample was taken for a pH and a solution viscosity measurement at 65° C. Next, 160 grams of 30% sodium hydroxide solution was added and the temperature was maintained at 76±2° C. Samples were withdrawn at 30 minute intervals for pH and solution viscosity measurements. While maintaining the temperature at 76±2° C., six additional shots of 30% sodium hydroxide solution totaling 220 grams were made. When the solution viscosity reached 18 cps (at 75° C.), the reaction temperature was lowered to about 70° C. to control the polymerization rate. At 28 cps (as measured at 65° C.), the reaction temperature was further lowered to about 64° C. to further slow down the polymerization rate. Once a viscosity of 68 cps (at 63° C.) was achieved the reaction was terminated by adding 40 grams of 95% sulfuric acid and 80 grams of tap water. Four samples were withdrawn along the reaction profile. The solids were adjusted to 32.3% and the pH to about 2.8±0.1. The final solution viscosities at pH 2.8 as measured at 25° C. were 118, 155, 180 and 212 cps, respectively.

Reaction of Diethlyene Triamine and Epichlorohydrin

In this example 310.9 grams of diethylene triamine (DETA), 2503.6 grams of tap water and 889.9 grams of the Epi were charged. The reaction temperature was adjusted to 76±2° C. Sampling was conducted every 30 minutes. A total of 572 grams of 30% sodium hydroxide solution was added. When the reaction mixture reached a viscosity of 10 cps (at 75° C.), the reaction temperature was lowered to about 68±2° C. to control the polymerization rate. At 88 cps (at 65° C.), the reaction was terminated by adding 40 grams of 95% sulfuric acid and 80 grams of tap water. Four samples were collected along the reaction profile. The product solids were adjusted to 31.2±0.2% and the pH to about 2.8±0.1. The final solution viscosities at a pH of 2.8 as measured at 25° C. were 175, 195 215 and 240 cps, respectively.

Production scale runs of the BHMT-Epi polymer were also monitored to determine the “in process” viscosity range for the reaction batch that would ultimately produce the most preferred target viscosity for the finished polymer product of between 175 and 225 cps at a pH of about 5.0 as measured by Brookfield at 35% solids and 25° C. Six production runs were monitored wherein the BHMT-Epi reaction was terminated using sulfuric acid once the “in process” reaction product viscosity fell within a certain range. Termination of the polymerization reaction was accomplished by adding sulfuric acid to a pH of about 5.0. The following table relates the “in process” reaction viscosity of the production run at the kickoff time for reaction termination to the final product solution viscosity at 35% solids.

TABLE I

Production Run No.

| | 1 | 2 | 3 | 4 | 5 | 6 |
|---|---|---|---|---|---|---|
| “In | 82 | 82 | 84 | 87 | 87 | 93 |
| Process” | | | | | | |
| Viscosity¹ | | | | | | |
| Final | 35.7 | 35.6 | 35.0 | 34.9 | 34.9 | 35.0 |
| Product | | | | | | |
| Solids %² | | | | | | |
| Finished | 203 | 218 | 185 | 183 | 193 | 235 |
| Product | | | | | | |
| Viscosity² | | | | | | |

Note:
¹Viscosity (as measured at 68° C.) of the BHMT-Epi batch at the time of reaction termination;
²Properties of final polymer product (solids and viscosity) at a pH of about 5.0 and 25° C.

As can be seen from Table I controlling the onset of reaction termination, via the addition of sulfuric acid to a pH of about 5.0, to coincide with an “in process” reaction viscosity of 82-90 cps (at 68° C.) results in a final BHMT-Epi polymer product viscosity that is within the desired target range for use in ASA emulsification.

The results of the above synthesis and production run investigations reveal that the degree of cross-linking and final product viscosity in the produced BHMT-Epi polymer is related to the manner of synthesis, and particularly to the point in time when the polymerization reaction is terminated via use of an acid. Thus, it is desirable to have the “in process” reaction batch viscosity in the range of around 82-90 cps (at 68±2° C.) before terminating the polymerization reaction by acidifying with sulfuric acid to a pH of about 5.0. This method thereby permits the desired final product derived from the reaction of BHMT and Epi to be produced having a finished solution viscosity range of around 175-225 cps at 35% solids and 25° C.

While epichlorohydrin is exemplified as one of the reactants, it is believed that any epihalohydrin would work as well in the process of forming the reaction polymer products of this invention, providing of course that the resultant molecular weight and degree of cross-linking as evidenced by the viscosity of the cationic polymer product, falls within the desired ranges. Likewise, while certain species of polyamines such as BHMT, DETA and TETA are exemplified above for use with epichlorohydrin as starting reaction materials, other analogous polyamines that generically fall into the family of amine compounds known as polyalkyleneamines are believed to be within the scope of the invention. Other examples of suitable polyalkyleneamines include, but are not limited to, ethylene-diamine (EDA), hexamethylenediamine (HMDA), tetraethylene-pentaamine (TEPA) and the like. Consequently, some exemplary cationic polymers useful in accordance with the present invention include bishexamethylenetriamine-epichlorohydrin, diethylenetriamine-epichlorohydrin, hexamethylenediamine-epichlorohydrin, triethylenetetraamine-epichlorohydrin, and tetraethylenepentaamine-epichlorohydrin.

The cationic polymer resulting from the reaction product of a polyalkyleneamine and an epihalohydrin with a final product solution viscosity in the range of about 50-300 cps based on 30-35% solids content and a product pH of about 2.5-5.0 as measured at 25° C. is shown herein to be an effective emulsifying agent for ASA in the sizing of paper and paperboard products. It should be understood that once the polyalkyleneamine-epihalohydrin polymer reaction product is made, it can be used with the ASA size for providing emulsification, with the resultant ASA emulsion being used for any purpose known in the art, and particularly for sizing applications in papermaking operations at virtually any desired location. The amounts of ASA size employed, on an active basis, can range from about 0.1 to about 20 pounds, preferably about 0.5 to about 10 pounds, per dry ton of paper depending on the level of benefit desired and the type of paper being produced. Referring now to FIG. 1, one example of a mixing arrangement 10 in a papermaking operation is shown, wherein the addition of the cationic polymer product is designated by the arrow 1. This material would be fed into a mechanical emulsifier system 3. The ASA size 5 is fed to the system 3 via a pump 7 and filter 9. The system 3 has an emulsifier 11 and a recirculating loop 12 that allows for control of the emulsification output 13. The output 13 is then fed to the appropriate location in the papermaking operation through backpressure valve 15 and filter 17. FIG. 1 also shows the simplicity of using the cationic polymer product by illustrating a prior art starch system that requires a starch cooker 21, cooling water inlet and outlet 23 and 25, and heat exchanger 27. There is no need for these components when using the reaction product 1 as a feed to the emulsification system 3.

The mixing performed by the emulsifier 11 should be sufficient to form a stable ASA emulsion having a median particle size ranging between 0.1 and 5.0 microns. More preferred median particle ranges are between 0.2 and 2.0, with a highly preferred target range between 0.5 and 1.5 microns. The amount of cationic polymer reaction product used to emulsify the ASA sizing agent is an effective amount to produce an emulsion particle size that is adequate for paper sizing performance. Another measure of the amount of cationic polymer reaction product needed for ASA emulsification is based on an active weight ratio of the cationic polymer to ASA sizing agent. A preferred weight ratio value of polymer to ASA for effective emulsification is at least 0.20:1.0 (polymer:ASA) to about 2.0:1.0 (polymer:ASA) as measured on an active basis weight ratio. A more preferred active basis weight ratio of polymer to ASA is about 0.5:1 to about 1.5:1.0. It should be understood that other systems could be employed for emulsifying the ASA with the cationic polymers of this invention, such as those systems disclosed in the referenced Nalco patent.

Once the ASA sizing agent has been emulsified, the ASA emulsion is fed to the papermaking operation. Typically, the ASA emulsion is formed on site at the papermaking operation as depicted in FIG. 1 using a dispersion device that employs high mixing shear such as a rotor/stator mixing system. The power of these high shear mixing units is typically around 8 to 40 horsepower, and between 10 and 100 liters of ASA can be emulsified per hour. The emulsified ASA can be added to the papermaking operation in any of a number of locations as is well known in the art. A preferred location for adding the emulsion of ASA sizing agent is the wet end of the papermaking operation, e.g., just before the secondary fan pump that precedes the screen leading to the headbox. Alternatively, the ASA emulsion could be applied to a paper substrate as a surface size by adding it to the size press located downstream of the drying stage of the operation. Of course, the ASA emulsion can be added to other locations of the papermaking operation as would be known in the art, and where the use of an emulsified ASA would be important for the papermaking operation.

Other additives as are known in the art can be employed in combination with the cationic polymer reaction product for use with the ASA size. One example would be to add a very small amount of a surfactant to help facilitate achieving the desired median particle size for the ASA emulsion that is being produced in the aforementioned mixing/dispersion processes. Cationic, anionic or nonionic types of surfactants can be utilized as co-additives with the cationic polymers of the instant invention to aide in ASA emulsification; however, nonionic and anionic surfactants are preferred for use on the basis of their Cobb sizing results. The amount of surfactant utilized is typically 3% or less by weight of the ASA size and preferably about 0.5-2% by weight of the ASA. The surfactants are preferably preblended with the ASA size for aiding the preparation of the polymer/ASA emulsions but the ASA, surfactant and cationic polymer can all be added separately during the ASA emulsification process. A surfactant chemistry and addition level that aides the ASA emulsification process without substantially decreasing the HST or Cobb sizing performance of the ASA size is desired. One of the important advantages of our invention is that the polyamine-epihalohydrin polymers enable effective ASA emulsions to be prepared without the need for high concentrations of surfactant.

In order to demonstrate the effectiveness of the cationic polymer reaction product of this invention as an emulsifier for ASA, a number of paper application studies making sizing efficiency comparisons were undertaken. The studies include a comparison of different polymer/ASA compositions in terms of the resultant median particle size of their emulsions, the relative paper sizing performance of these ASA emulsions using Hercules Size Testing (HST), and Cobb testing. In all the sizing studies hereinafter reported, a commercially available ASA sizing agent sold by Kemira under the tradename Hydrores AS1000 was used as the source of the ASA starting material. Compositionally, the Hydrores AS1000 is principally an octadecenyl succinic anhydride in >96.5% purity. A wide array of polymer/ASA weight ratios were accordingly examined with the Hydrores AS1000 in producing the subject ASA emulsions. The median particle size properties of the ASA emulsions were determined by laser light scattering measurements using a Horiba particle size analyzer. Variations in ASA emulsion particle size and paper sizing performance as a function of the cationic polymer chemistry employed were also explored by changing the starting polyalkyleneamine chemistry used in making the cationic polymer that was ultimately employed as the ASA emulsifying agent, and by altering the molecular weight and degree of cross-linking properties of the resulting polyalkyleneamine-epihalohydrin polymers as monitored by solution viscosity measurements on the finished polymer. Two types of viscosity measurements have been employed in these polymer characterizations: Brookfield viscosity measurements of the polymers at specified spindle, rpm, % solids, pH and temperature conditions and intrinsic viscosity measurements. The Brookfield viscosity measurements were all made using a LVT unit equipped with either a #1 or #2 spindle (as appropriate) spinning at 60 rpm unless otherwise noted. Intrinsic viscosity (I.V.) values for the cationic polymers were determined using Ubbelohde dilution viscometer tubes and a Schott AVS-450 automated viscosity measuring station. The I.V. measurement temperature was 30° C. and the solvent system employed was an aqueous solution of 0.2M NaCl. Also, the polymer solution concentrations were chosen such that the highest concentrations were two to three times the efflux time of the 0.2M NaCl solvent's efflux time. For each test polymer, at least three polymer solution concentration levels were run in triplicate in determining its I.V. value.

The HST test is a standard test in the papermaking industry for measuring the degree of sizing, also known as TAPPI Standard Method, T530 om-02 and officially named “Size test for paper by ink resistance (Hercules-type method).” The test employs an aqueous dye solution as a penetrant to permit optical detection of the liquid front as it moves through a paper sheet being tested. The time required for the reflectance of the sheet surface not in contact with the penetrant to drop to a predetermined percentage of its original reflectance is measured. The testing data reported herein measures the seconds to 80% reflectance with a 1% formic acid ink. Higher HST values indicate that it takes more time for penetration of the ink, and indicate better sizing performance. The test was performed essentially as written with two exceptions. All tests were run on the wire side. Also, the method calls for each data point to be an average of 10 tests. The test papers were hand sheets which were destroyed in the testing and the average of 10 tests was therefore not available for each data point.

The Cobb Test is a TAPPI Standard Method, T441 om-98, having an official name as “Water absorptiveness of sized (non-bibulous) paper, paperboard, and corrugated fiberboard.” Cobb testing measures the water absorbed by a specific area of paper surface over a given period of time, such as 60 seconds, and is measured in grams/square meter. The lower the Cobb test measurement, the more resistant the paper is to water absorption. The testing procedures used herein followed the TAPPI standard except that tap water was used instead of distilled or deionized water, and all tests were run on the wire side. The TAPPI method calls for each data point to be an average of 10 tests, but since the test papers were hand sheets which were destroyed in the testing, therefore an average of 10 tests for each data point could not be attained.

The Horiba LA-300 analyzer measures the particle size distribution properties by angular light scattering techniques. When light goes into a spherical particle, three types of light scatter will be emitted. The LA-300 uses seven separate sets of detectors, six for the wide angle and back scattering, and a detector array composed of 36 elements for the forward scattering. A particle's scattered light differs according to its size. In conducting the particle size measurements, a selected weight ratio of cationic reaction polymer and ASA is emulsified in an Osterizer blender on the highest setting for 2 minutes. The Horiba unit will align and blank to get the background. After the unit blanks, the emulsion (10 mg to 5g) is then dropped into the chamber until the % T (Transmittance) bar drops to an optimum range. The emulsion droplet is then measured for its particle size distribution. The median particle diameter, the mean particle diameter, the descriptive shape of the distribution curve, and the particle diameter size in microns at the 10% and 95% volume fractions are recorded. The median particle diameter of a good ASA emulsion will typically be from 0.5 to 1.5 microns in size. The median is the value of the particle size for which 50% of the particles are equal to or below that value. The mean is the arithmetic average particle size.

The test samples used in the various comparisons set forth below were made using a high-speed lab Osterizer blender rather than the commercial mixing equipment normally employed to emulsify ASA. In commercial applications, the ASA emulsion is formed on site using high shear rotor/stator mixing systems. The power of these units is typically from around 8 to around 40 horsepower. Usually, between 10 and 100 liters of ASA sizing agent can be emulsified in one hour and the ASA emulsion is generally added just before the fan pump in the papermaking operation. For lab testing purposes though, an Osterizer blender was employed wherein the emulsions were produced at a mixing speed of 20,000 RPM at ambient temperatures. A volume of 200 ml was used for all samples. The emulsifying cationic polymer was added to the mix water to a concentration of 0.5 wt. % based on solids content, with the required ASA amount being subsequently added according to the desired active weight ratio of polymer:ASA as defined by the particular sizing experiment being conducted. The remainder was water. The Osterizer blender was run on its highest speed for two minutes. The resulting emulsion was immediately added to a Britt jar where it was mixed with stock and then formed into a hand sheet for testing.

In all the subsequent handsheet sizing studies, stock for making the handsheets was prepared using a blend of 50:50 hardwood/softwood bleached kraft market pulp. The pulp was refined with a laboratory scale Valley beater to a freeness value of 500. As previously described, the ASA emulsions were prepared using an Osterizer blender for 2 minutes set at high speed. An aliquot of the ASA emulsion appropriate for the desired addition level of ASA was added to the stock via the use of a syringe. Addition of the ASA emulsion to the stock was done within 20 seconds of the emulsion's preparation. A Britt jar was used in mixing the stock and thoroughly incorporating the experimental ASA emulsions that were being added via the syringe. In these ASA treatment runs, 800 ml of 1% consistency stock was added to the Britt jar. The added ASA emulsion was mixed with the stock for 30 seconds at a Britt jar mixing speed of 1,000 rpm. After the 30 second mix, the agitator was turned off and 200 ml aliquots of ASA treated stock were taken from the Britt jar for making handsheets for testing. The stock was formed into handsheets with a TAPPI hand sheet former using a procedure similar to TAPPI T205, “Forming Handsheets for Physical Testing of Pulp”. The handsheet weight was 2.0 gm. A pneumatic roller press was used for pressing. The handsheets were pressed between blotters and dried with a drum drier in 2 passes. The first pass was between blotters while the second pass was just the handsheet. The drum drier temperature was set at 220° F. The sheets were subsequently cured for 10 minutes at 105° C. before testing.

Sizing Performance and Median Particle Size Comparison

For comparative purposes, a number of different cationic polymer/ASA emulsions were prepared and evaluated for their emulsion particle size properties and paper sizing performance. From these initial evaluations, select ASA emulsions were chosen and compared with a more traditional cationic starch based system. Table II lists 6 different cationic polymer products that are all commercially available from Kemira and are derived from Epichlorohydrin (Epi) based condensation reactions with an organic amine compound. Within this cationic polymer series the starting amine compound varies and ranges from being either a simple monomeric amine (like dimethylamine), a polyamidoamine or a polyalkyleneamine. The Epi based condensation polymers of Table II are listed there by their associated commercial trade name along with a brief chemical description of each product, their respective % solids contents, the weight ratio of cationic polymer to ASA sizing agent used to make the test emulsions of ASA, and the resultant HST sizing results when these emulsions were used as an internal sizing additive for paper. A 1:1 active basis weight ratio of cationic polymer to ASA was used in the study and the total addition level to the 50/50 hardwood to softwood bleached kraft market pulp was 4 pounds of active ASA size per ton of dry pulp.

TABLE II

| Polymer | Chemical Composition of | Polymer | Polymer/ASA | HST_{80%}, |
|---|---|---|---|---|
| Tradename | Cationic Polymer | Solids % | Active Basis Wt. Ratio | Seconds |
| Fiber | | | | <1 |
| Blank | | | | |
| Callaway | Reaction of Dimethyl | 50 | 1:1 | <1 |
| 4000 | Amine with Epi | | | |
| Callaway | Callaway 4000 plus | 50 | 1:1 | <1 |
| 4005 | small amount of | | | |
| | Ethylene Diamine to | | | |
| | cross-link and build | | | |
| | molecular weight | | | |
| Callaway | Callaway 4005 with a | 50 | 1:1 | <1 |
| 4015 | greater amount of | | | |
| | Ethylene Diamine | | | |
| Callaway | Polyamidoamine of | 30 | 1:1 | 110 |
| 4063 | Diethylene Triamine & | | | |
| | Adipic Acid that is | | | |
| | then reacted with Epi | | | |
| Callaway | Same components as | 40 | 1:1 | <1 |
| 5821 | Callaway 4063, but | | | |
| | different production | | | |
| | method | | | |
| Discol | Reaction product of | 35 | 1:1 | 442 |
| 716* | bis-Hexamethylenetriamine | | | |
| | (BHMT) and Epi | | | |

Note:
*Brookfield Viscosity of the Discol 716 was 90 cps.

As is evident from Table II, the Callaway 4063 and Discol 716 polymers provide vastly superior HST sizing results as compared to the other Epi based condensation polymers. These sizing results are believed to be the collective result of the charge density, molecular weight and cross-linked nature of these polymers which apparently aides ASA emulsification and likely enables greater retention of the ASA size through promoting attachment of the ASA to the cellulose fibers. It should be noted that the Callaway 4063 product is similar to the cationic polyamide resin taught in the Rohlf patent discussed above; however, this chemistry is not nearly as effective as the cationic polyalkyleneamine-Epi chemistry of the Discol 716 product.

The two highest performing polymers from Table II (Callaway 4063 and Discol 716) were selected for a subsequent test comparison against ASA that had been emulsified with a cationic starch for paper sizing performance. The cationic starch employed was a 25% active basis liquid starch from Penford, named Topcat L76, which is a highly cationized potato starch and it was used on an “as received” basis at 4 pounds per ton of ASA. Versus this cationic starch/ASA system, Table III shows the comparative results using different weight ratios of emulsifying agent to ASA for the different cationic polymeric emulsifiers. In all the experiments the total amount of ASA size added to the pulp for internal sizing purposes was 4 lbs of active ASA per ton of dry pulp.

TABLE III
ASA Emulsion Particle Size and HST Sizing Results
(HST @ 80% Reflectance, 1% Formic Acid)

| | Emulsifier/ASA Ratio | Median Particle | HST |
|---|---|---|---|
| | (ratio on as rec'd | Size of ASA | Avg., |
| Expt. # | basis)* | Emulsion, micron | sec. |
| A | Fiber Blank | | 0.2 |
| B | 1:1 Penford Topcat | 1.88 | 6.8 |
| | L76/ASA | | |
| C | 1:1 Callaway | 1.25 | 0.3 |
| | 4063/ASA | | |
| D | 1.5:1 Callaway | 0.98 | 0.3 |
| | 4063/ASA | | |
| E | 2:1 Callaway | 0.93 | 0.3 |
| | 4063/ASA | | |
| F | 2.5:1 Callaway | 0.91 | 0.7 |
| | 4063/ASA | | |
| G | 1:1 Discol 716/ASA | 3.17 - Bimodal | 0.4 |
| H | 1.5:1 Discol 716/ASA | 0.95 | 0.7 |
| I | 2:1 Discol 716/ASA | 0.90 | 45.3 |
| J | 2.5:1 Discol 716/ASA | 0.90 | 677.7 |

Note:
*Total active basis addition level of ASA size was held constant at 4 lbs/ton of dry pulp.

As can be seen from Table III, the Discol 716/ASA sizing emulsion performed the best when the “as is” weight ratio of cationic polymer to ASA was at least 2:1, with a ratio of 2.5:1 showing an excellent HST sizing value in excess of 677 seconds. In terms of an active basis comparison, experimental samples I and J of Table III had active basis weight ratios of polymer:ASA of 0.7:1 and 0.875:1, respectively. It should be noted that the results clearly show the superior paper sizing performance of the ASA emulsions that were emulsified with the Discol 716 (a polyalkyleneamine-Epi polymer) as compared to the use of the Callaway 4063 (a polyamidoamine-Epi polymer). The test results also indicate that paper sizing performance with the Discol 716 polymer/ASA system improves as the relative amount of cationic polymer that is used as an emulsifying agent is increased with respect to the ASA amount.

As seen in Table IV, a third comparative sizing study was made between a cationic polymer designed to simulate the cationic vinyl-addition polymers of the Nalco patent, and the same Discol 716 polymer previously used in Tables II and III. It should be noted that the commercial sample of Discol 716, which is a polymeric reaction product made from BHMT and Epi, as utilized in the comparative studies of Tables II-IV had a Brookfield viscosity of 90 cps as measured at 35% solids and 25° C. More specifically in Table IV, the ASA emulsification and sizing experiments were done using laboratory produced samples of acrylamide (AMD)/quaternary-functional acrylate or methacrylate copolymers of the type that are described in the Nalco patent cited above. The ratio of AMD/quaternary-functional acrylate or methacrylate monomers employed in making the prior art cationic copolymer samples was 75/25 on a weight basis. The quaternary-functional mononer specifically used in making the cationic vinyl-addition based copolymers of the Nalco art is a quaternary-functional methacrylate that is chemically described as dimethylaminoethyl methacrylate methyl chloride quat (commonly denoted as DMAEM—Me Cl Quat). Since producing the cationic vinyl-addition polymers disclosed in the Nalco patent involve known synthesis techniques, a further discussion of the details of making these cationic polymers is not necessary for understanding the current invention. The laboratory produced 75/25 ratio AMD/DMAEM—Me Cl quat copolymer samples of Table IV (designated as polymer samples K through S) were made to encompass a wide molecular weight range with final solution viscosities ranging from as low as 163 centipoise (cps) to as high as 39,000 cps. The other variables associated with the prior art copolymers such as % solids content, weight ratio of polymer to ASA, and the amount of emulsified ASA used for paper sizing are also shown in Table IV. Two ASA addition levels of 4 lbs and 6 lbs of active basis ASA per ton of dry pulp were used in the study, with the active basis weight ratio of polymer to ASA maintained at 0.7:1 (polymer:ASA). Median particle size properties for the ASA emulsions and resultant HST sizing values are also listed for each experiment in Table IV. This table shows that only one of the comparative copolymer samples, i.e., polymer sample Q used at 6 lbs of active basis ASA per ton of pulp (Expt.# 8b) which is the highest molecular weight polymer of the polymer test series exhibited any sizing by the HST evaluation method. This HST result is still very low in comparison to the HST sizing result of Expt.# lb of Table IV, thus demonstrating that the use of the Discol 716 type polymer chemistry unexpectedly provides superior HST sizing performance as compared to other cationic polymers previously employed in the art for ASA emulsification. Also noteworthy is the fact that the sole comparative polymer that exhibited good sizing performance (polymer sample Q) also caused noticeable deposition on the emulsification test equipment, and could not be used commercially for this reason. Thus, in comparison to the prior art technology the polyalkyleneamine-Epi based chemistry of Discol 716 yielded surprisingly better HST sizing performance while causing little to no accompanying problems with deposit formation.

TABLE IV
ASA Emulsion Particle Size and HST Sizing Results
(HST @ 80% Reflectance, 1% Formic Acid)

| | | | PL:ASA | | Median | |
|---|---|---|---|---|---|---|
| | Polymer | | (active | | Particle | HST |
| | Product & | % | basis wt. | #/Ton | Size, | Avg., |
| Expt# | BF Visc. | Solids | ratio) | ASA | microns | sec. |
| 1a | (Discol | 35 | 0.7:1 | 4 | 0.90 | 41.2 |
| | 716) | | | | | |
| | Visc. = | | | | | |
| | 90 cps | | | | | |
| 1b | | | | 6 | | 1048.3 |
| 2a | (K) | 13.8 | 0.7:1 | 4 | 1.82 - | 0.4 |
| | Visc. = | | | | Bimodal | |
| | 1780 cps | | | | | |
| 2b | | | | 6 | | 2.8 |
| 3° | (L) | 14.5 | 0.7:1 | 4 | 0.92 | 0.3 |
| | Visc. = | | | | | |
| | 163 cps | | | | | |
| 3b | | | | 6 | | 0.5 |
| 4a | (M) | 14 | 0.7:1 | 4 | 4.49 - | 0.4 |
| | Visc. = | | | | Bimodal | |
| | 1148 cps | | | | | |
| 4b | | | | 6 | | 2.7 |
| 5a | (N) | 13.8 | 0.7:1 | 4 | 4.81 - | 0.3 |
| | Visc. = | | | | Bimodal | |
| | 1484 cps | | | | | |
| 5b | | | | 6 | | 1.0 |
| 6a | (O) | 13.8 | 0.7:1 | 4 | 2.22 - | 0.4 |
| | Visc. = | | | | Bimodal | |
| | 2120 cps | | | | | |
| 6b | | | | 6 | | 2.5 |
| 7a | (P) | 13.6 | 0.7:1 | 4 | 4.01 - | 0.4 |
| | Visc. = | | | | Trimodal | |
| | 1000 cps | | | | | |
| 7b | | | | 6 | | 0.7 |
| 8a | (Q) | 14.2 | 0.7:1 | 4 | 6.89 - | 0.7 |
| | Visc. = | | | | Bimodal | |
| | 39,000 cps | | | | | |
| 8b | | | | 6 | | 55.1 |
| 9a | (R) | 14 | 0.7:1 | 4 | 2.21 - | 0.3 |
| | Visc. = | | | | Bimodal | |
| | 636 cps | | | | | |
| 9b | | | | 6 | | 0.6 |
| 10a | (S) | 13.7 | 0.7:1 | 4 | 4.28 - | 0.3 |
| | Visc. = 485 cps | | | | Trimodal | |
| 10b | | | | 6 | | 0.5 |

Polymer Viscosity Comparison and Effect on Sizing Performance

In order to analyze the effect of finished polymer viscosity, for the inventive cationic polymers, on ASA emulsion preparation and resultant paper sizing performance, a number of experimental variants of the Discol 716 polymer chemistry were prepared in the laboratory and characterized by viscosity testing. The Discol 716 type polymers are produced by the condensation reaction of the polyamine BHMT with Epi as previously described whereby the commercial version of the 716 product typically has a Brookfield viscosity between 50 and 100 cps at 35% solids and 25° C. Experimental BHMT-Epi polymers of different product viscosity were produced in the lab by terminating the polymerization reaction at different time points along the reaction profile via the addition of sulfuric acid to a pH of about 5.0 as previously discussed. All the finished BHMT-Epi polymers were adjusted to about 35% solids and their viscosities were measured at 60 rpm and 25° C. Table V compares the product viscosity results for five (5) different variants of the Discol 716 chemistry, hereinafter designated as polymer samples T-X, demonstrating that cationic polymer viscosities ranging from a low of 60 cps to a high of 400 cps can be readily achieved synthetically. It should be noted that the BHMT-Epi polymers of Table V were all produced by the specific reaction process conducted at the higher reactor solids content and higher peak exothermic temperature conditions (44.8% solids and 123° C.).

TABLE V
Solution Viscosity of Experimental BHMT-Epi Polymers

| Expt'l Polymer | BF Visc., cps @ 35% |
|---|---|
| Sample | solids & 25° C. |
| T | 60 |
| U | 100 |
| V | 160 |
| W | 250 |
| X | 400 |

In the next step of our evaluations, cationic polymer samples T-X were then used as polymeric emulsifiers for ASA to yield a series of ASA emulsions that were tested for paper sizing efficiency as part of a statistical based experimental design program. A full factorial design was developed for this experimental work using Minitab 14 which is a statistical analysis software package. In addition to polymer product viscosity as represented by the various cationic BHMT-Epi polymer samples of Table V, the experimental factorial design incorporated cationic polymer/ASA ratio and ASA dosage level as factors related to the prepared ASA size emulsions. Cationic polymer/ASA active basis weight ratios of 0.5:1, 0.75:1, 1.0:1 and 1.5:1 were included as factors in the design. Active basis ASA dosage levels of 2, 3 and 4 lbs. of ASA per ton of dry pulp were explored in the design. The ASA size emulsions generated by this experimental design were then evaluated for paper sizing efficiency by preparing and testing our standard 2.0 gm handsheets as previously described.

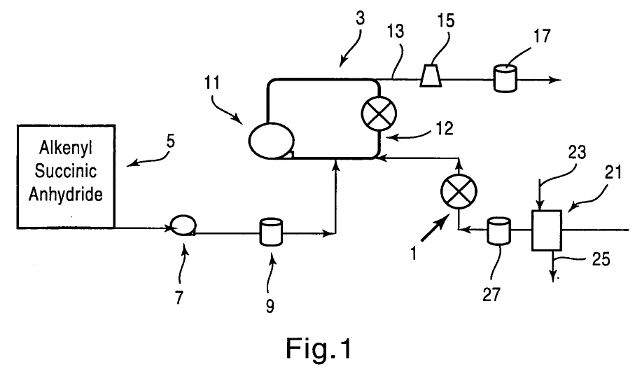

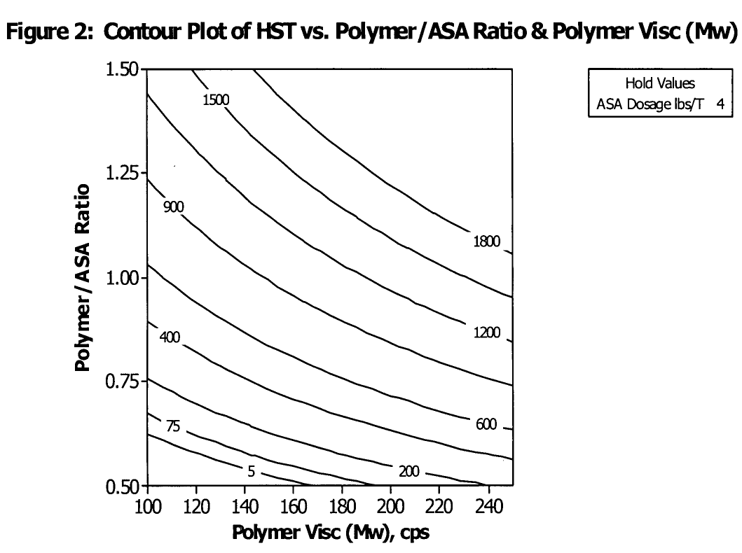

The HST sizing results and observed performance trends obtained from evaluating the above experimental design are graphically illustrated in the contour plots labeled as FIGS. 2-4. In FIGS. 2-4, the HST sizing performance of the ASA emulsions is presented as HST contours plotted as a function of different factor combinations. In FIG. 2, at a constant ASA dosage level of 4 lbs. per ton, the combined effect that cationic polymer/ASA ratio and cationic polymer viscosity have on HST sizing performance can be observed. At a given cationic polymer/ASA ratio, such as 0.75:1, an increase in HST sizing performance can be seen as the cationic polymer's product viscosity is increased from 100 to 250 cps. Furthermore, for a particular cationic polymer, such as a polymer having a Brookfield product viscosity of 160 cps, one observes that HST sizing performance is rapidly increased as the cationic polymer/ASA ratio is increased.

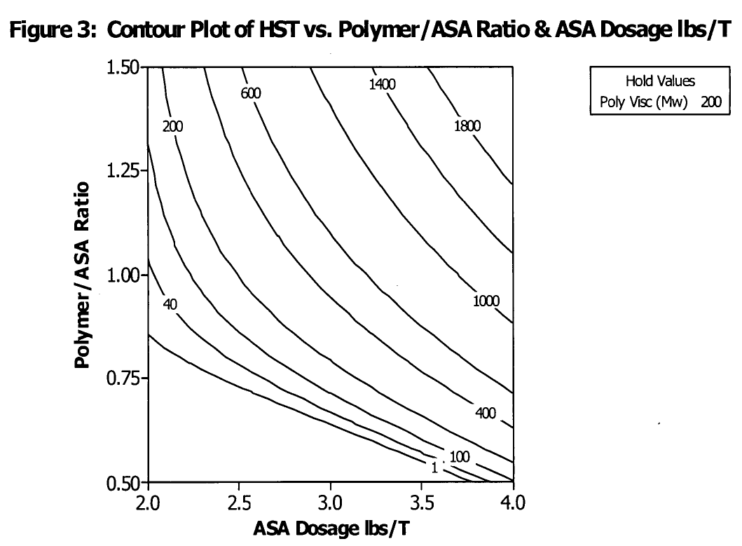

In FIG. 3, using a single cationic polymer of 200 cps viscosity, the combined effect that cationic polymer/ASA ratio and ASA dosage level have on HST sizing performance can be observed. At a given cationic polymer/ASA ratio, such as 1.0:1, a rapid increase in HST sizing performance can be seen as the ASA dosage level is increased from 2 to 4 lbs. per ton of dry pulp. Also, at a particular ASA dosage level like 3 lbs. of active ASA per ton of dry pulp, one observes that the HST sizing performance is increased as the cationic polymer/ASA ratio is increased. In FIG. 3, it is also commercially important to note that ASA dosage levels of about 4 lbs. of active ASA per ton of pulp were needed to give acceptable HST sizing performance when using cationic polymer/ASA ratios of 0.50:1 to 0.75:1. However, the use of a cationic polymer/ASA ratio of about 1.0:1 provides the extra flexibility of employing lower dosage levels of ASA to achieve acceptable HST sizing performance.

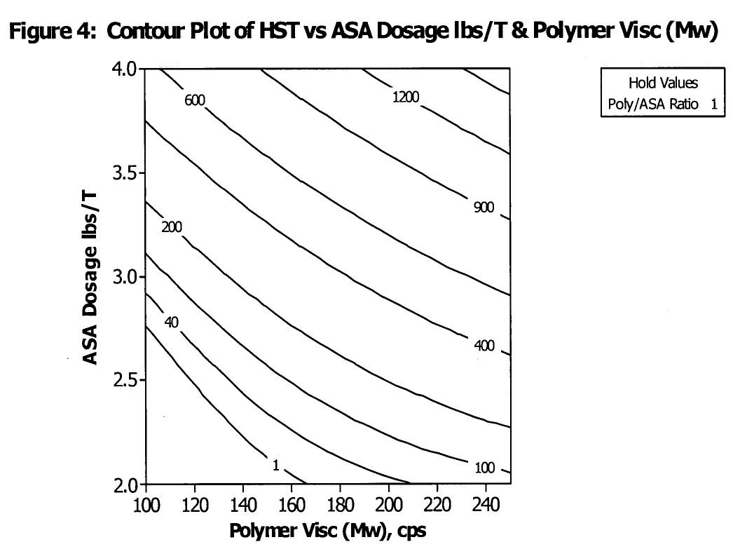

In FIG. 4, using a constant cationic polymer/ASA ratio of 1.0:1, the combined effect that ASA dosage level and cationic polymer viscosity have on HST sizing performance can be observed. As in the previous contour plots, the HST sizing performance is observed to significantly increase as either the ASA dosage level or the cationic polymer viscosity is increased.

In conclusion, the contour plots of HST sizing performance that are presented in FIGS. 2-4 demonstrate that ASA dosage level, cationic polymer/ASA ratio and the cationic polymer product's viscosity are all significant factors in the HST paper sizing performance of the ASA emulsions. For each of these experimental factors, an increase in their respective input values results in improved HST paper sizing performance. For that reason, it is preferred that one employs a BHMT-Epi cationic polymer of at about 175 to 225 cps with a target of about 200 cps at a cationic polymer/ASA ratio of at least about 0.75:1 and then adds the ASA size emulsion to paper for internal sizing at a ASA dosage level of at least about 3 lbs. per ton of dry pulp to achieve good HST sizing results. However, based on the results shown in FIGS. 2-4 and the comparative testwork of Table II, use of a reaction product based on a polyamine and an epihalohydrin with a viscosity as low as 50 cps would provide the unexpected improvements in sizing performance when used in combination with substituted cyclic dicarboxylic acid anhydride sizing agents such as ASA, e.g., the commercial Discol 716 product exemplified above.

While using BHMT-Epi cationic polymers of higher viscosity than 300 cps as emulsifying agents for ASA can yield further increases in paper sizing performance, such cationic polymers are not preferred for use overall because of their increased potential to form papermachine deposits. The formation of deposits on papermachine surfaces can often inhibit the runnability performance of the papermaking process and also negatively impact the quality of the paper produced. An experimental means to determine the relative deposition potential of various ASA emulsions using the BHMT-Epi polymers of Table V was devised whereby a cationic polymer/ASA ratio of 1.0:1 was employed and 10 lbs. of active ASA per ton of dry pulp was added to create a worst case type deposit scenario. The ASA emulsions were added to 1400 gm of furnish which was comprised of a 10% consistency pulp slurry of 125 dry gm of Copy Paper plus 15 dry gm of Old Newsprint with the rest being water. A standard stock mixer test that employs an Osterizer dough mixer equipped with plastic coated mixing paddles was used for these evaluations in order to determine the relative amount of deposition of organic deposits onto the surface of the plastic coated paddles. In addition, the turbidities, particle size properties and cationic demand of the resulting filtrates obtained from the ASA treated furnishes were measured for comparison. Based on the observed differences in the filtrate properties, polymer sample X of Table V showed increased potential for causing deposit issues given that its filtrate turbidity value was low (<1,500 NTU's) and the median particle size of its filtrate liquor was in excess of 25 microns. These results suggest the BHMT-Epi cationic polymer employed for ASA emulsification should preferably be chosen to have a product viscosity value <about 300 cps when measured at 35% solids and 25° C.

Additional HST, Cobb and Particle Size Test Comparisons

Based on the cationic polymer viscosity versus size performance testing presented above, cationic polymer sample V (which has a Brookfield product viscosity of 160 cps) was selected and compared to a commercial polymer sample of a cationic vinyl-addition type copolymer obtained from Nalco as the emulsifier for ASA. An FT-IR analysis was done on the commercial sample, and the spectrum indicated that the polymer appears to be the same 75/25 ratio AMD/DMAEM—Me Cl quat copolymer that is disclosed in the Nalco patent art. Tables VI and VII show a direct performance comparison between polymer sample V of Table V and the Nalco commercial sample designated as Nalsize. Sizing performance was compared by collecting HST and Cobb test data. As in previous test work, Kemira's Hydrores AS1000 was used as the source of ASA sizing agent.

TABLE VI
Hercules Size Test for Cationic Polymers
used for ASA Emulsification
(HST @ 80% Reflectance, 1% Formic Acid)

| Polymer | PL:ASA active | HST Avg., |
|---|---|---|
| Sample | basis Wt. Ratio | seconds |
| V | 0.5:1.0 | 429.5 |
| V | 1.0:1.0 | 881.7 |
| Nalsize | 0.5:1.0 | 11.2 |
| Nalsize | 1.0:1.0 | 12.6 |

The comparative sizing tests of Tables VI and VII were run at two different cationic polymer/ASA active basis weight ratios, namely: 0.5:1, and 1.0:1. The dosage level of ASA size used in each internal sizing test was maintained at 4 lbs. of active basis ASA per ton of dry pulp and the paper testing was carried out on our standard 2.0 gm handsheets made of 50/50 hardwood/softwood bleached kraft market pulp. The HST results of Table VI show that the sizing performance of the sheets formed using the cationic polymer/ASA emulsions according to the instant invention were far superior to the HST sizing of the sheets formed using the Nalco cationic copolymer as the ASA emulsifier. In contrast to these HST findings, the Cobb sizing results of Table VII indicate that the different cationic polymers provide similar performance levels when used as polymeric emulsifiers for ASA. Cobb testing is a measure of water hold out performance.

TABLE VII
Cobb₆₀ Size Test for Cationic Polymers used for
ASA Emulsification

| Polymer | PL:ASA active | |
|---|---|---|
| Sample | basis Wt. Ratio | Cobb₆₀, gm/m² |
| V | 0.5:1.0 | 19.9 |
| V | 1.0:1.0 | 22.5 |
| Nalsize | 0.5:1.0 | 24.6 |
| Nalsize | 1.0:1.0 | 22.9 |

Laser light scattering particle size analysis was also run on all the ASA test emulsions (via use of a Horiba LA-300 particle size analyzer) that were used in making the ASA sizing performance comparisons of Tables VI and VII. The results of this particle size analysis at two different polymer/ASA ratios are shown in Table VIII.

TABLE VIII
Particle Size Analysis of ASA Emulsions

| Polymeric | | |
|---|---|---|
| Emulsifier | PL:ASA active | Median Particle |
| Sample | basis Wt. Ratio | Size, microns |
| V | 0.5:1.0 | 0.81 |
| V | 1.0:1.0 | 0.85 |
| Nalsize | 0.5:1.0 | 0.30 |
| Nalsize | 1.0:1.0 | 0.21 |

All the ASA emulsions were acceptable with respect to the final median particle size that was produced. However, the Nalsize cationic copolymer did provide somewhat smaller emulsion droplets of ASA size which may be due to the co-presence of a surfactant in their product as mentioned in their patent.

Test Comparisons of Different Polyamine-EPI Chemistries

In this example, the HST and Cobb sizing performance of various ASA emulsions prepared from different polyalkyleneamine-Epi chemistries were evaluated and compared as internal sizing agents. The cationic polymers utilized in this sizing study were polyalkyleneamine-Epi polymers of similar viscosity but they were produced from three different polyalkyleneamine starting materials, namely: BHMT, DETA and TETA. The synthesis of cationic polymers from these specific polyalkyleneamines has been previously described. The three cationic polymers were used as the emulsifiers for the ASA size and ASA test emulsions having cationic polymer/ASA active basis weight ratios ranging from 0.25:1 to 1.0:1 were produced. These ASA emulsions were then added to our standard test stock at 2 lbs and 3 lbs of active basis ASA per ton of dry pulp. HST and Cobb values were then determined on the 2.0 gm handsheets. The HST and Cobb sizing results are summarized in Tables IX and X.

TABLE IX
HST Sizing Performance of ASA Emulsions Prepared with Different
Polyamine-Epi Chemistries
(HST @ 80% Reflectance, 1% Formic Acid)

| | BF Visc @ | PL:ASA | HST with | HST with |
|---|---|---|---|---|
| | 25° C. of | Active | ASA @ | ASA @ |
| Starting | Polyamine- | Basis | 2 lbs/Ton, | 3 lbs/Ton, |
| Polyamine | Epi Polymer* | Wt. Ratio | sec. | sec. |
| DETA | 215 cps @ | 0.25:1 | 0.7 | 2.6 |
| | 31.2% solids | | | |
| | | 0.50:1 | 1.6 | 230.0 |
| | | 0.75:1 | 17.2 | 543.3 |
| TETA | 180 cps @ | 0.25:1 | 0.9 | 3.3 |
| | 32.3% solids | | | |
| | | 0.50:1 | 3.7 | 425.4 |
| | | 0.75:1 | 53.3 | 561.2 |
| BHMT | 198 cps @ | 0.25:1 | 1.2 | 21.8 |
| | 35.0% solids | | | |
| | | 0.50:1 | 13.4 | 624.8 |
| | | 0.75:1 | 447.9 | 907.6 |

Note:
*DETA and TETA based polymers were acidified to pH 2.8; BHMT based polymer was acidified to pH 5.0

The HST sizing results of Table IX indicate that the DETA and TETA based cationic polymers can emulsify ASA to produce effective ASA emulsions for internally sizing paper. However, the HST sizing results also indicate that the BHMT based cationic polymer is the most effective polymer of the test series. This performance difference may be a consequence of the more hydrophobic hexamethylene chains present within BHMT versus the ethylene chains in DETA and TETA and/or a consequence of differences in the degree of cross-linking.

The Cobb sizing results of Table X show similar performance trends to the HST data. The DETA and TETA based polymer/ASA emulsions provided reasonably good Cobb sizing performance once a cationic polymer/ASA ratio of 0.75:1 at an ASA dosage level of 3 lbs/ton was utilized. However, the BHMT based systems were again superior in sizing performance to either the DETA or TETA systems as the BHMT based polymer allowed low Cobb values to be obtained at only 2 lbs of ASA addition per ton of dry pulp at a cationic polymer/ASA ratio of 0.75:1. At higher polymer/ASA ratios, like 1.0:1, the differences in Cobb sizing performance between the different cationic polymers were largely diminished. These results suggest that the BHMT-Epi polymer may be more effective in promoting retention of the ASA size to the cellulose fibers.

TABLE X
Cobb₆₀ Sizing Performance of ASA Emulsions Prepared with
Different Polyamine-Epi Chemistries

| | BF Visc @ | PL:ASA | Cobb with | Cobb with |
|---|---|---|---|---|
| | 25° C. | Active | ASA @ | ASA @ |
| Starting | of Polyamine- | Basis | 2 lbs/Ton, | 3 lbs/Ton, |
| Polyamine | Epi Polymer* | Wt. Ratio | gm/m² | gm/m² |
| DETA | 215 cps @ 31.2% | 0.25:1 | 104.9 | 85.8 |
| | solids | | | |
| | | 0.50:1 | 99.6 | 21.6 |
| | | 0.75:1 | 76.4 | 18.8 |
| | | 1.00:1 | 25.2 | 21.3 |
| TETA | 180 cps @ 32.3% | 0.25:1 | 109.9 | 79.4 |
| | solids | | | |
| | | 0.50:1 | 83.8 | 20.4 |
| | | 0.75:1 | 61.3 | 18.8 |
| | | 1.00:1 | 27.6 | 17.7 |
| BHMT | 198 cps @ 35.0% | 0.25:1 | 109.9 | 72.3 |
| | solids | | | |
| | | 0.50:1 | 49.2 | 22.6 |
| | | 0.75:1 | 21.0 | 18.5 |
| | | 1.00:1 | 21.3 | 19.3 |

Note:
*DETA and TETA based polymers were acidified to pH 2.8; BHMT based polymer was acidified to pH 5.0

For the ASA test emulsions presented in Tables IX and X, the corresponding ASA emulsion particle size values were determined by analysis with a Horiba LA-300 particle size analyzer. For comparison, the particle size properties of the ASA emulsions prepared at a cationic polymer/ASA active basis weight ratio of 0.75:1 are reported in Table XI for all three polymer chemistries. The mean and median particle size results indicate that the BHMT-Epi polymer was the most effective in producing a finer particle size ASA emulsion having a more narrow distribution of droplet sizes as compared to the test emulsions using cationic polymers derived from either DETA or TETA. The finer particle size properties for the BHMT based ASA emulsions are therefore in agreement with their superior paper sizing performance.

TABLE XI
Particle Size Analysis of ASA Emulsions Prepared with Different
Polyamine-Epi Chemistries

| | BF Visc @ 25° C. | PL:ASA | Median | Mean |
|---|---|---|---|---|
| Starting | of Polyamine- | Active Basis | P.S., | P.S., |
| Polyamine | Epi Polymer* | Wt. Ratio | microns | microns |
| DETA | 215 cps @ 31.2% | 0.75:1 | 2.33 | 3.88 |
| | solids | | | |
| TETA | 180 cps @ 32.3% | 0.75:1 | 1.43 | 2.35 |
| | solids | | | |
| BHMT | 198 cps @ 35.0% | 0.75:1 | 0.89 | 1.36 |
| | solids | | | |

Note:
*DETA and TETA based polymers were acidified to pH 2.8; BHMT based polymer was acidified to pH 5.0

Intrinsic Viscosity Properties of Polyamine-EPI Polymers

In this example, the intrinsic viscosity (I.V.) properties of four different series of polyalkyleneamine-Epi polymers that show utility as cationic polymers for the effective emulsification of ASA size were characterized. The I.V. value for each cationic polymer was determined at 30° C. and in a 0.2M NaCl solution by the analysis methodology previously described. The I.V. values for each cationic polymer series (series I-IV) are summarized, respectively, in Tables XII-XV.

Tables XII and XIII summarize the I.V. values for two different series of BHMT-Epi polymers. Polymer Series I (of Table XII) was produced by the BHMT plus Epi reaction procedure that has previously been described as the higher reactor solids, higher peak exothermic temperature process (44.8% solids and 123° C.). The paper sizing performance of ASA emulsions prepared with the Series I polymers has been previously discussed and the HST results can be found in the contour performance plots of FIGS. 2-4. In comparison, polymer Series II (of Table XIII) was produced by the lower reactor solids, lower peak exothermic temperature procedure (38.3% solids and <100° C.) for the BHMT plus Epi reaction process. The paper sizing performance of cationic polymer/ASA emulsions prepared from polymer sample AA (of Table XIII) has also been comprehensively studied and previously discussed (see the BHMT-Epi polymer of 198 cps viscosity in Tables IX, X and XI). Polymer sample AA provided good ASA emulsion particle size and sizing results.

Review of the test data for polymer Series I and II indicates a similar range of I.V. values; however, the Series II polymers consistently yield slightly higher I.V. values across the Brookfield viscosity range examined. Both polymer series independently yield a very good linear relationship between I.V. and Brookfield viscosity whose least squares fit to a line has a R² correlation coefficient of about 0.99. The linear equation describing Series I is I.V.=0.0006(BF Viscosity)+0.1525 while the linear equation describing Series II is I.V.=0.0006(BF Viscosity)+0.1801. Use of the linear equations defined by the least square analysis of these two data sets indicate that a cationic polymer having a desired target Brookfield viscosity of 200 cps would correlate to an I.V. value of 0.2725 dL/gm (for Series I polymers) as compared to an I.V. value of 0.3001 dL/gm (for Series II polymers). Similarly, a direct comparison of polymer sample V with polymer sample Y, which have very similar Brookfield viscosity values at 35% solids, shows the same trend in that polymer sample Y of Series II has a somewhat greater I.V. value. These differences in I.V. can likely be attributed to differences in the extent of cross-linking in the polymers. The lower I.V. values for the Series I polymers, which are produced at a higher reactor solids content, suggest that they proportionally have more cross-linking relative to the Series II polymers of similar Brookfield viscosity. A lower I.V. value for a more cross-linked cationic polymer would be expected since the degrees of freedom and range of molecular motion for these polymers in a particular solvent would be less; hence, they would occupy less volume per unit gram of polymeric material.

TABLE XII
Brookfield Viscosity vs. Intrinsic Viscosity Measurements
of Experimental BHMT-Epi Polymers: Series I

| | | Intrinsic |
|---|---|---|
| Expt'l Polymer | BF Visc., cps (@ 35% | Viscosity, dL/gm |
| Sample | solids, pH 5 & 25° C.) | (30° C. & 0.2M NaCl) |
| T | 60 | 0.1768 |
| U | 100 | 0.2073 |
| V | 160 | 0.2528 |
| W | 250 | 0.2995 |
| X | 400 | 0.3510 |

TABLE XIII
Brookfield Viscosity vs. Intrinsic Viscosity Measurements
of Experimental BHMT-Epi Polymers: Series II

| | | Intrinsic |
|---|---|---|
| Expt'l Polymer | BF Visc., cps (@ 35% | Viscosity, dL/gm |
| Sample | solids, pH 5 & 25° C.) | (30° C. & 0.2M NaCl) |
| Y | 150 | 0.2778 |
| Z | 190 | 0.3004 |
| AA | 198 | 0.3076 |
| BB | 240 | 0.3355 |

Tables XIV and XV respectively summarize the I.V. values for a series of polyalkyleneamine-Epi polymers prepared from TETA and DETA polyamines. The preparation of these cationic polymers has been previously described. Also the ASA emulsion particle size and paper sizing performance properties of polymer samples EE (of Table XIV) and JJ (of Table XV) have been previously reported in Tables IX, X and XI. Both cationic polymers provided acceptable results in terms of ASA emulsion particle size and paper sizing performance although they did not perform quite as well as the preferred BHMT-epi polymers per polymer series I or II.

Review of the I.V. data for the TETA and DETA based cationic polymers (per polymer series III and IV) indicates these polymers provide I.V. values within the same general range as the BHMT-Epi polymers of series I and II. Consequently the performance of these polymers, like the BHMT-Epi polymers, can be correlated to a high degree with their product viscosities.

Based on correlating the overall end-use performance properties of various polyalkyleneamine-Epi polymers with the polymer's I.V. values, the preferred cationic polymers having good utility as emulsifiers for ASA can be broadly described as having an I.V. value of about 0.18-0.35 dL/gm as measured at 30° C. in a 0.2M NaCl solution. The cationic polymers that are most preferred as emulsifiers for ASA have an I.V. value of about 0.25-0.34 dL/gm. Those having an I.V. value well below 0.18 dL/gm provide reduced sizing performance while those well above 0.35 dL/gm show increased tendency to create papermachine deposits. In terms of the polymer's Brookfield solution viscosity properties at 25° C. for solids contents of 30-35%, the preferred cationic polymers have a Brookfield viscosity of about 50-300 cps while those that are most preferred fall into the Brookfield viscosity range of about 175-225 cps.

TABLE XIV
Brookfield Viscosity vs. Intrinsic Viscosity Measurements of
Experimental TETA-Epi Polymers: Series III

| | | Intrinsic Viscosity, |
|---|---|---|
| Expt'l Polymer | BF Visc., cps (@ 32.3% | dL/gm (30° C. & 0.2M |
| Sample | solids, pH 2.8 & 25° C.) | NaCl) |
| CC | 118 | 0.2750 |
| DD | 155 | 0.3100 |
| EE | 180 | 0.3188 |
| FF | 212 | 0.3358 |

TABLE XV
Brookfield Viscosity vs. Intrinsic Viscosity Measurements of
Experimental DETA-Epi Polymers: Series IV

| | | Intrinsic Viscosity, |
|---|---|---|
| Expt'l Polymer | BF Visc., cps (@ 31.2% | dL/gm (30° C. & 0.2M |
| Sample | solids, pH 2.8 & 25° C.) | NaCl) |
| GG | 175 | 0.3089 |
| HH | 195 | 0.3114 |
| JJ | 215 | 0.3311 |
| KK | 240 | 0.3404 |

Use of Surfactants in Preparing Polyamine-EPI/ASA Emulsions

In this example, the effect that auxiliary surfactant addition has on the median particle size and sizing performance properties of the ASA emulsions that are prepared with the cationic polymers of the instant invention was examined. A number of different surfactant chemistries were examined, as listed in Table XVI, at additive levels of either 1% or 2% of the ASA on an active weight basis. In each case the surfactant was preblended with the ASA size. The surfactant treated ASA and cationic polymer were then mixed together with water for 2 minutes in an Osterizer blender set at high speed to form an ASA emulsion for subsequent sizing use. The active basis weight ratio of cationic polymer to ASA that was employed in all our experiments was 0.5:1. The cationic polymer employed was a BHMT-Epi polymer of 35.2% solids and 5.2 pH having a Brookfield product viscosity of 203 cps at 25° C. The resultant ASA emulsions were then added to 1% consistency pulp at an addition level of 3 lbs of active basis ASA per ton of dry pulp and our standard 2 gm handsheets were produced for testing purposes. The test results from this program are summarized in Table XVII.

TABLE XVI

| Surfactant | Chemical Description of | HLB Value of |
|---|---|---|
| Tradename | Surfactant | Surfactant |
| Burcoquat TS20 | Quaternary based | Not Known |
| | Cationic surfactant | |
| Alfonic 1412-7 | Nonionic Surfactant: | 12.0 |
| | C₁₂-C₁₄ linear alcohol | |
| | ethoxylate with 7 moles | |
| | EO | |
| Rhodasurf BC-610 | Nonionic Surfactant: | 11.4 |
| | Tridecyl alcohol | |
| | ethoxylate with 6 moles | |
| | EO | |
| Tergitol 15-S-7 | Nonionic Surfactant: | 12.4 |
| | C₁₁-C₁₅ secondary | |
| | alcohol ethoxylate with | |
| | 7 moles EO | |
| Rhodafac RE-610 | Anionic Surfactant: | Not Known |
| | Phosphate Ester of a | |
| | Nonylphenol Ethoxylate | |

TABLE XVII

| | | | Cobb₁₈₀ | HST_{80%} with |
|---|---|---|---|---|
| | Surfactant | Median Particle Size | with ASA @ | ASA @ |
| Surfactant | Level, Wt. | of 0.5:1 PL/ASA | 3 lbs/Ton, | 3 lbs/Ton, |
| Additive | % of ASA | Emulsion, microns | gm/m² | seconds |
| None | 0 | 0.87 | 32.0 | 598 |
| Burcoquat | 1.0 | 0.60 | 99.5 | 416 |
| TS20 | | | | |
| Alfonic | 1.0 | 0.65 | 33.8 | 437 |
| 1412-7 | | | | |
| Rhodasurf | 1.0 | 0.67 | 42.6 | 443 |
| BC-610 | | | | |
| Tergitol | 1.0 | 0.65 | 34.5 | 546 |
| 15-S-7 | | | | |
| Tergitol | 2.0 | 0.59 | 79.9 | 423 |
| 15-S-7 | | | | |
| Rhodafac | 1.0 | 0.69 | 32.8 | 481 |
| RE-610 | | | | |
| Rhodafac | 2.0 | 0.55 | 50.9 | 500 |
| RE-610 | | | | |

As demonstrated by the finer median particle size values reported in Table XVII, the addition of small amounts of surfactant to the ASA sizing agent (Hydrores AS1000) aided its emulsification. The paper sizing data indicate that select surfactants can be employed at a 1% additive level (as based on the weight of ASA) without having a significant deleterious effect on final Cobb or HST sizing performance. Particularly promising was the use of the nonionic surfactant Tergitol 15-S-7 at a 1% addition level to the ASA size. The anionic surfactant Rhodafac RE-610, while not quite as good as Tergitol 15-S-7, was also an acceptable surfactant choice when employed at a 1% additive level. In contrast the cationic surfactant Burcoquat TS20 had a significant deleterious impact on Cobb sizing performance even at a 1% addition level although the surfactant aided emulsion particle size formation.

While the emulsified ASA size is exemplified in papermaking operations, and particularly those making sized cover sheets for gypsum wallboard, any process needing an emulsified ASA size could be used in connection with the present invention. While the emulsification of the sizing agent and the cationic reaction polymer for a later use, e.g., in a papermaking operation, is exemplified using an aqueous solvent media, e.g., water, the sizing agent and cationic reaction polymer can be emulsified using a non-aqueous solvent media, e.g., an alcohol, if so desired without departing from the scope of the invention.

As such, an invention has been disclosed in terms of preferred embodiments thereof, which fulfill each and every one of the objects of the present invention as set forth above and provides a new and improved method for emulsifying ASA and using an emulsified product therefrom.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. In a method of emulsifying a substituted cyclic dicarboxylic acid anhydride size, wherein an emulsifying agent as a cationic polymer is added to the substituted cyclic dicarboxylic acid anhydride size in an effective amount for emulsification purposes, the improvement comprising using a cationic reaction polymer formed from a condensation reaction of an epihalohydrin and a polyamine as the emulsifying agent, the cationic reaction polymer in a final product stage having a Brookfield viscosity ranging between 50 and 300 cps at 25° C. and 30-35% solids or an intrinsic viscosity value of about 0.18-0.35 dL/gm as measured at 30° C. in a 0.2M NaCl solution.

2. The method of claim 1, wherein the polyamine is a polyalkyleneamine.

3. The method of claim 2, wherein the polyalkyleneamine is one of bishexamethylenetriamine, triethylene tetraamine, and diethlyene triamine.

4. The method of claim 1, wherein the epihalohydrin is epichlorohydrin.

5. The method of claim 4, wherein the polyamine is a polyalkyleneamine.

6. The method of claim 5, wherein the polyalkyleneamine is one of bishexamethylenetriamine, triethylene tetraamine, and diethylene triamine.

7. The method of claim 1, wherein the substituted cyclic dicarboxylic acid anhydride size has the formula: 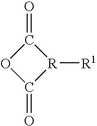
wherein R is a dimethylene or trimethylene radical and wherein R¹ is a hydrophobic substituent containing more than 5 carbons.

8. The method of claim 7, wherein the substituted cyclic dicarboxylic acid anhydride is an alkenyl succinic anhydride.

9. The method of claim 1, wherein the Brookfield viscosity ranges between 175 and 225 cps.

10. The method if claim 1, wherein the intrinsic viscosity value ranges between 0.25 and 0.34 dL/gm.

11. The method of claim 1, further comprising the step of adding an effective amount of the emulsified substituted cyclic dicarboxylic acid anhydride for sizing purposes to one or more sites in a papermaking operation.

12. The method of claim 11, wherein the one or more sites include sites on the wet end of the papermaking operation or at or near a size press of the papermaking operation.

13. The method of claim 11, wherein the papermaking operation produces cover sheet for gypsum wallboard.

14. The method of claim 1, wherein an active weight ratio of the cationic reaction polymer to the substituted cyclic dicarboxylic acid anhydride size ranges between about 0.20 to 2.0 parts of the cationic reaction polymer to 1.0 part of the substituted cyclic dicarboxylic acid anhydride size.

15. The method of claim 1, wherein a synthesis of the cationic reaction polymer is controlled by monitoring viscosity of the cationic reaction polymer and terminating the synthesis by lowering the pH of a solution containing the cationic reaction polymer in order to achieve said Brookfield viscosity range or said intrinsic viscosity range.

16. The method of claim 15, wherein the pH is lowered to between about 2.5 and 5.2.

17. The method of claim 11, wherein the effective amount of the emulsified substituted cyclic dicarboxylic acid anhydride size employed in the papermaking operation is based on an active basis of substituted cyclic dicarboxylic acid anhydride size, the effective amount ranging from about 0.1 to about 20 pounds of the substituted cyclic dicarboxylic acid anhydride size per dry ton of paper.

18. The method of claim 1, further comprising employing an effective amount of a surfactant for enhanced emulsification and particle size control with the cationic reaction polymer and substituted cyclic dicarboxylic acid anhydride size.

19. The method of claim 18, wherein the surfactant is about 3% or less by weight based on the dry weight of the emulsified substituted cyclic dicarboxylic acid anhydride size.

20. In an emulsion comprising a cationic polymer emulsifying agent and a substituted cyclic dicarboxylic acid anhydride size, the improvement comprising a cationic reaction polymer formed from a condensation reaction of an epihalohydrin and a polyamine as the emulsifying agent, the cationic reaction polymer in a final product stage having a Brookfield viscosity ranging between 50 and 300 cps at 25° C. and 30-35% solids or an intrinsic viscosity value of about 0.18-0.35 dL/gm as measured at 30° C. in a 0.2M NaCl solution.

21. The emulsion of claim 20, wherein the polyamine is a polyalkyleneamine.

22. The emulsion of claim 21, wherein the polyalkyleneamine is one of bishexamethylenetriamine, triethylene tetraamine, and diethlyene triamine.

23. The emulsion of claim 20, wherein the epihalohydrin is an epichlorohydrin.

24. The emulsion of claim 23, wherein the polyamine is a polyalkyleneamine.

25. The emulsion of claim 24, wherein the polyalkyleneamine is one of bishexamethylenetriamine, triethylene tetraamine, and diethylene triamine.

26. The emulsion of claim 20, wherein the substituted cyclic dicarboxylic acid anhydride size has the formula: 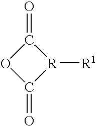
wherein R is a dimethylene or trimethylene radical and wherein R¹ is a hydrophobic substituent containing more than 5 carbons.

27. The emulsion of claim 26, wherein the substituted cyclic dicarboxylic acid anhydride is an alkenyl succinic anhydride.

28. The emulsion of claim 20, wherein the Brookfield viscosity ranges between 175 and 225 cps.

29. The emulsion of claim 20, wherein the intrinsic viscosity value ranges between 0.25 and 0.34 dL/gm.

30. The emulsion of claim 20, wherein an active weight ratio of the cationic reaction polymer to the substituted cyclic dicarboxylic acid anhydride size ranges between about 0.20 to 2.0 parts of the cationic reaction polymer to 1.0 part of the substituted cyclic dicarboxylic acid anhydride size.

31. The method of claim 20, further comprising an effective amount of a surfactant for enhanced emulsification and particle size control with the cationic reaction polymer and substituted cyclic dicarboxylic acid anhydride size.

32. The method of claim 31, wherein the surfactant is about 3% or less by weight based on the dry weight of the emulsified substituted cyclic dicarboxylic acid anhydride size.

33. A paper composition comprising cellulosic fibers, and a combination of a substituted cyclic dicarboxylic acid anhydride sizing agent and a cationic reaction polymer associated with the cellulosic fibers, the cationic reaction polymer formed from a condensation reaction of an epihalohydrin and a polyamine, wherein the combination of the substituted cyclic dicarboxylic acid anhydride size and cationic reaction polymer are added as an emulsion in an amount ranging from about 0.1 to about 20 pounds of active basis substituted cyclic dicarboxylic acid anhydride size per dry ton of cellulosic fibers.

34. The paper composition of claim 33, wherein an active weight ratio of the cationic reaction polymer to the substituted cyclic dicarboxylic acid anhydride size ranges between about 0.20 to 2.0 parts of the cationic reaction polymer to 1.0 part of the substituted cyclic dicarboxylic acid anhydride size.
